(19) United States
(12) Patent Application Publication
(10) Pub. No.: US 2005/0274212 A1
(43) Pub. Date: Dec. 15, 2005

(54) Mechanical movement module for part transfer system

(76) Inventor: Luciano Trindade De Sousa Monteiro, Sao Caetano do Sul - SP (BR)

Correspondence Address: John R. Benefiel, Suite 100 B, 280 Daines Street, Birmingham, MI, 48009, US

(21) Appl. No.: 10/858,575

(22) Filed: Jun. 1, 2004

(51) Int. Cl. B25J 17/00

(52) U.S. Cl. 74/89.22; 74/490.04

(57) ABSTRACT

A mechanical movement module is described which executes successively a horizontal motion followed by a vertical motion of a support platform upon rotation of a rotary input drive in a first direction and reverses the successive motions upon reversing the rotary input drive. A flexible belt engages sprockets and guide wheels to carry a first carriage horizontally before driving a lift plunger vertically to raise a second carriage mounted on the first carriage. A limit stop is engaged by the first carriage at the end of the horizontal movement, causing the belt having ends fixed to the lift plunger to drive the lift plunger upwardly.

### BACKGROUND OF THE INVENTION

This invention concerns mechanical movements involving two sequential linear motions in directions orthogonal to each other. Part transfer systems, as are used in stamping presses for example, often involve a horizontal motion of part grippers combined with a sequential vertical motion. The grippers are moved inwardly to be able to grip the part, and then moved vertically to lift the parts out of their stations. A separate indexing motion then carries the parts and grippers forward. The grippers and parts are lowered to deposit the parts in their respective next stations, the grippers then retracted outwardly.

These two orthogonal motions are often achieved with two separate drives and controls, which increases the complexity and cost of the apparatus.

In the present inventor's earlier U.S. Pat. No. 5,941,119, a single drive produces successive horizontal and vertical movements, to thus provide a simpler system than the multiple drive mechanisms.

It is an object of the present invention to provide a mechanical movement which produces successive horizontal and vertical movement operated by a single drive which further reduces the cost and complexity of the mechanism shown in U.S. Pat. No. 5,941,119.

### SUMMARY OF THE INVENTION

The above received object and other objects which will become apparent upon a reading of the following specification and claims are achieved by a first carriage mounted on a base for linear horizontal movement. A second carriage provides a support platform for the grippers which is mounted on the first carriage on a vertical guide. The second carriage supports a part gripper or other device.

A flexible drive belt is passed around a drive sprocket at one end of the module and around an idler sprocket at the other end. The drive belt has one end segment which is guided into a vertical path by a first guide wheel, passing around a third sprocket and extending down along side and fixed to a lift plunger included in the second carriage. Another end segment is also guided into a vertical path by a second guide wheel, extending up on the other side of the lift plunger to which it is fixed. The two guide wheels and the third sprocket are carried on the first carriage structure.

When the belt is driven, the reaction of one of the guide wheels to the belt tension carries the first carriage horizontally along its supporting slide until a fixed stop is engaged.

Thereafter, the belt tension causes the lift plunger and other second carriage structure connected to the belt one end is lifted up, carrying the second carriage platform and grippers up with it.

Upon reversal of the belt drive, the vertical lift plunger and second carriage is first lowered to engage a rest, and thereafter the first carriage is horizontally retracted to its initial position.

The weight of the first and second carriages, guide wheels, third sprocket, lift plunger and grippers, is relied on to resist the tendency of the belt tension to drive the vertical lift plunger up prior to engagement of the first carriage with the limit stop. If friction in the horizontal slide is too great, the lifting tendency may be positively resisted with a bearing supported guide plate blocking lifting of the lift plunger until the horizontal travel of the first carriage is completed.

### DESCRIPTION OF THE DRAWINGS

FIG. 1 is an enlarged side elevational view of a mechanical movement module according to the invention, with a supported gripper mechanism.

FIG. 2 is an end view of the mechanical movement module shown in FIG. 1, the gripper mechanism not shown.

FIG. 3 is a horizontal section taken through the mechanical movement module as shown in FIG. 2.

FIG. 4 is a side elevational reduced size view of the mechanical movement module shown in FIG. 1 in the starting position, together with a supported gripper mechanism supported on the module.

FIG. 4A is a diagrammatic representation of the start position of the mechanical movement module shown in FIG. 4.

FIG. 5 is a side elevational view of the mechanical movement module shown in FIG. 4, with the carriages moved to the end of the horizontal travel thereof.

FIG. 5A is a diagrammatic representation of the shifted position of the mechanical movement module shown in FIG. 5.

FIG. 6 is a side elevational view of the mechanical movement module shown in FIG. 5, with the second carriage driven to its elevated position.

FIG. 6A is a diagrammatic representation of the position of the mechanical movement module shown in FIG. 6.

FIG. 7 is a side elevational view of the mechanical movement module shown in FIG. 6, with the second carriage lowered by drive of the belt drive in a reverse direction.

FIG. 7A is a diagrammatic representation of the position of the mechanical movement module shown in FIG. 6.

FIG. 8 is a side elevational view of the mechanical movement module shown in FIG. 7 with the carriages moved back to their starting position by continued reverse drive of the drive belt.

FIG. 8A is a diagrammatic representation of the position of the mechanical movement module shown in FIG. 8.

FIG. 9 is a side elevational view of some of the components of a modified version of a mechanical movement module according to the invention, together with a supported gripper mechanism.

FIG. 9A is an end view of the components shown in FIG. 9.

FIG. 10 is a plan view of an array of four mechanical movement modules according to the invention installed in a transfer mechanism.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

The present invention involves a mechanical movement module producing a motion sequence comprised of an initial horizontal movement and thereafter a vertical movement by continued operation of a rotary input. Such sequenced motion is useful in part transfer systems particularly for indexing parts as in a stamping press through successive forming stations. As a part of this indexing, part grippers are moved in to engage the outer edges of a part, the part then elevated preparatory to being indexed forward by a separate transfer mechanism.

After indexing, the movements are reversed, i.e., the grippers are first lowered to deposit the part in the next ahead station, and, after the grippers are released, the grippers are moved horizontally out, and then indexed back to a start position. A series of parts are often moved in this manner through a series of successive form stations.

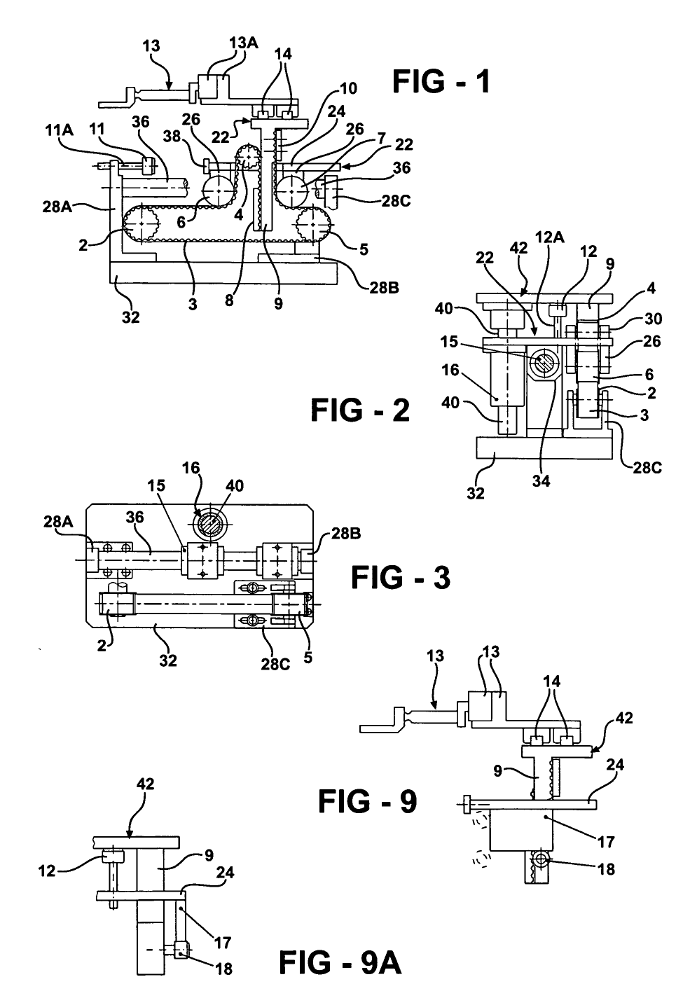

FIG. 1 shows a mechanical movement module 20 according to the present invention, in which a platform 42 mounts a gripper mechanism 13, and rails 13A and linear bearing 14 therefore.

A rotary input driver shaft 1 has a drive sprocket 2 affixed thereto, which in turn engages an elongated flexible drive element here comprised of a toothed belt 3 which has an upper segment which extends horizontally to the left and passes around the drive sprocket 2.

A lower run of the belt 3 then extends back horizontally and passes around an idler sprocket 5 mounted on a base spaced from the drive sprocket 2 at the other end of the mechanical movement module 20.

A pair of guide wheels 6 and 7 and a third sprocket 4 located vertically above the wheels 6, 7 divert the belt 3 from its looped path around the sprockets 2 and 5 to create a pair of vertical segments of the belt 3.

A lift plunger 9 has opposite ends of the belt 3 attached to respective sides thereof with retainer bars 8 and 10 respectively.

The lift plunger 9 is thereby held stationary by the belt 3 when the belt 3 is not being driven by the shaft 2, resting on a rest 12 (FIG. 2) adjustably mounted on a first carriage 22.

The pulleys 6, 7, sprocket 4, and lift plunger 9 are all supported on the first carriage 22 including a plate 24, brackets 26, 30 supporting the pulleys 6, 7, and sprocket 4 respectively.

The first carriage 22 is attached to a bracket 34 mounting a linear guide 15 slidable on a horizontal guide shaft 36 held at either end by bracket 28A and bracket 28B on a base plate 32.

Another bracket 28C supports idler sprocket 5 above the base plate 32.

Fixed brackets 28A, 28B and 28C are all mounted to the base plate 32.

The first carriage 22 also includes an abutment 38 affixed to plate 24 extending towards an adjustable limit stop 11 at the end of a threaded shaft 11A received in upright of bracket 28A. Limit stop 11 is fixed relative the first carriage 22.

The lift plunger 9 is a part of a second carriage 42 affixed to its upper end providing a support platform 42 for the grippers 13, rails 13A and linear bearings 14 mounting the gripper 13 on the second carriage 42.

A vertical slide 40 passes through a linear bearing 16 attached to the first carriage 22 and is affixed to the underside of the second carriage 42. Thus, the first carriage 22 mounts the second carriage 32 for vertical movement thereon.

An adjustable rest 12 is mounted on a threaded shaft 12A received in plate 24 of the first carriage 22. This locates the second carriage 32 in its lowered or down position.

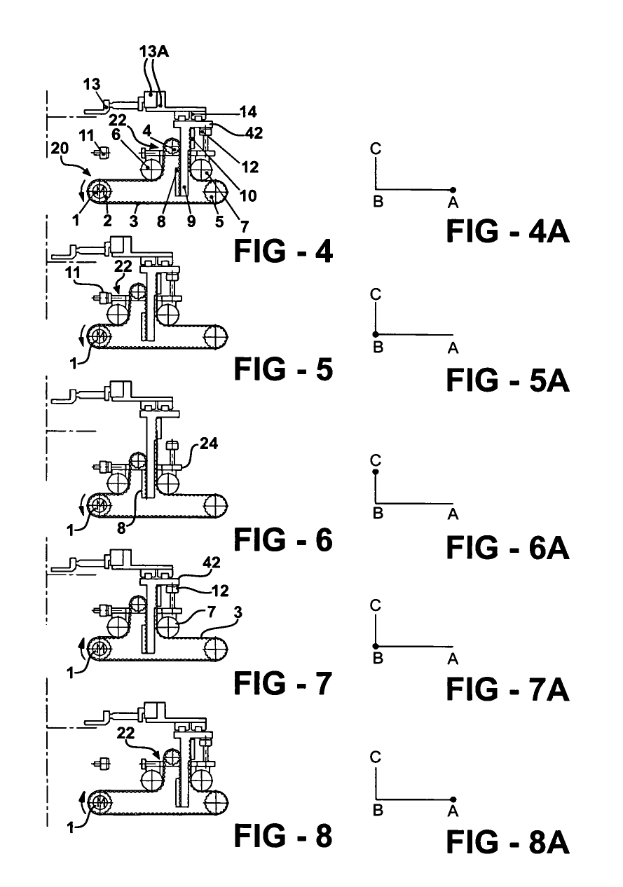

In operation, as seen in FIGS. 4-8, when the driver shaft 1 is rotated clockwise as seen in FIG. 4, the tension developed in the drive belt 3 causes a reaction force at the guide wheel 6 resulting in linear displacement of the first carriage 22 (and the second carriage 42 mounted thereon) to the left on the shaft 36 until abutment 38 contacts stop 11, as seen in FIG. 5.

At this point, tension developed in the left end of the drive belt 3 below the sprocket 4 pulls the lift plunger 9 up carrying the second carriage 32 vertically up to elevate the grippers 13 and associated hardware, as seen in FIG. 6. The retainer bar 8 will abut the underside of plate 24 in this elevated position.

The drive shaft 1 is then driven in the reverse direction, causing the right end of the belt 3 to pull the lift plunger 9 down until the platform 42 is lowered onto the rest 12, as seen in FIG. 7.

Thereafter, the reaction force on the guide wheel 7 shifts the first carriage 22 (together with the second carriage 42) horizontally back to the start position shown in FIG. 8.

It will be noted that the weight of the first and second carriages 22 is relied on to overcome the friction in linear bearing 15 and other resistance in the components to horizontal movement without any vertical movement of the lift plunger 9.

In order to insure this result, FIGS. 9 and 9A show a modification in which a fixed guide plate 17 located beneath plate 24 engages a roller 18 extending from one side of the lift plunger 9. This positively restrains the lift plunger 9 from any vertical movement until after the lift plunger roller 8 passes beyond the guide plate 17 at the end of the horizontal movement of the first carriage 22.

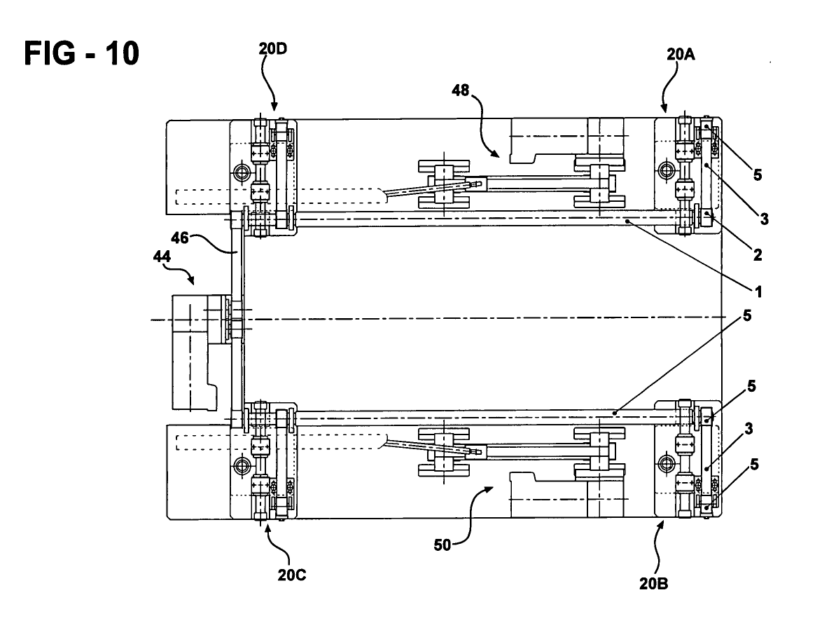

FIG. 10 shows a plurality of modules 20A-20D can be interconnected for synchronized movement by a common drive comprised of a common drive comprised of a drive shaft 1 drive by a single rotary drive 44 via belt 46.

Indexing drive components 48, 50 are shown which index the modules 20A-20D to index the parts (not shown).

1. A mechanical movement module for successively producing a horizontal and a vertical motion of a platform, comprising:
a first carriage and a bearing support mounting said first carriage on a base for horizontal motion;
a second carriage supported on said first carriage for vertical motion, said platform mounted on said second carriage;
a flexible drive element having a first segment extending horizontally around a drive sprocket rotatably mounted on a drive shaft relatively fixed with respect to said base;
said drive element passing around and engaging said drive sprocket and extending horizontally back from said drive sprocket to an idler sprocket supported on said base; drive sprocket, said first guide wheel;
said drive element having one end extending away from said drive sprocket and segment passing around a first guide wheel rotatably supported on said first carriage adjacent said drive sprocket at a location spaced from said drive sprocket, said one end extending vertically up from said first guide wheel and back around a third sprocket also rotatably supported on said first carriage, thence vertically downwardly, said drive belt one end attached to one side of a lift plunger included in said second carriage;
an opposite end of said drive element extending from said idler sprocket around a second guide wheel rotatably supported on said first carriage, said opposite end extending vertically up alongside said lift plunger and attached thereto;
a limit stop fixed relative said first carriage engaged by said first carriage after a predetermined horizontal travel thereof carrying said guide wheels and third sprocket therewith, engagement of said first carriage with said fixed limit stop causing said drive element one end to pull said second carriage and said platform vertically up, whereby said platform is initially moved horizontally away from a start position with said first and second carriages, and then vertically after said first carriage engages said limit stop; said second carriage and said platform initially lowered upon reverse driving of said first sprocket and thereafter moved horizontally back together with said first carriage.

2. The module according to claim 1 wherein said flexible drive element comprises a toothed belt engaged with teeth on said idler and drive sprockets.

3. The module according to claim 1 further including a rest mounted on said first carriage engaged by said second carriage after moving vertically down upon reverse driving of said first sprocket.

4. The module according to claim 1 wherein said second carriage is guided in its vertical motion by a vertical slide spaced from said lift plunger supported in a linear bearing mounted on said first carriage.

5. The module according to claim 1 wherein said first carriage is slidably supported for horizontal movement by a horizontal shaft affixed to said base, having a bearing mounted thereto received on said shaft.

6. The module according to claim 1 wherein the weight of said first and second carriages prevents vertical movement of said lift plunger while overcoming friction in said bearing support.

7. The module according to claim 1 wherein a fixed guide plate engages a roller on said lift plunger until said first carriage engages said limit stop preventing vertical motion of said second carriage until after said carriages are moved horizontally.
